(19) United States
(12) Patent Application Publication
(10) Pub. No.: US 2007/0155228 A1
(43) Pub. Date: Jul. 5, 2007

(54) AUTOMATIC LEVELING MOUNT SYSTEM

(76) Inventors: Dino R. Nama, Rancho Santa Margarita, CA (US); William J. Kozlowski JR., Tega Cay, SC (US)

Correspondence Address: LAW OFFICES OF LARRY K. ROBERTS, INC., 2 Park Plaza, Suite 300, Irvine, CA, 92614, US

(21) Appl. No.: 11/567,130

(22) Filed: Dec. 5, 2006

Related U.S. Application Data
(60) Provisional application No. 60/742,756, filed on Dec. 6, 2005.

(51) Int. Cl. H01R 13/60

(52) U.S. Cl. 439/567

(57) ABSTRACT

A mount system is described. An exemplary embodiment is a device that provides rotary damping to a mounted device, e.g. a camera system, when mounted to a moving arm. As the arm changes attitude, the mount system allows dampened rotary movement of the mounted device about an axis, due to gravity forces.

### CROSS-REFERENCE TO RELATED APPLICATION

This application claims the benefit of U.S. Provisional Application No. 60/742,756 filed Dec. 6, 2005, hereby incorporated by reference.

### BACKGROUND

Camera positioning systems may be used with video or still cameras, or other vision systems, e.g. scene surveillance systems for use on aerial platform trucks and command centers. The platform to which the camera is mounted may be movable, resulting in difficulties in maintaining a camera angle.

### BRIEF DESCRIPTION OF THE DRAWINGS

FIG. 1 is front plan view illustrating an exemplary embodiment of a vehicle on which is mounted a camera system. FIG. 1A is an enlarged view of the encircled portion 1A of FIG. 1. FIG. 1B is an isometric view of an exemplary embodiment of the camera system mounted on the vehicle of FIG. 1.

FIG. 2 is an isometric view of an exemplary embodiment of a mount system.

FIG. 3A is an exploded right frontal isometric view of the mount system of FIG. 2. FIG. 3B is an exploded left frontal isometric view of the mount system of FIG. 2.

FIGS. 4A-4B are respective left frontal and right frontal isometric views of an exemplary embodiment of a hanger structure comprising the mount system of FIG. 2.

FIGS. 5A-5B are respective right frontal and left frontal isometric views of a left base mount comprising the mount system of FIG. 2.

FIG. 6 is a cross-sectional view of an exemplary embodiment of a mount system, taken along line 6-6 of FIG. 2.

### DETAILED DESCRIPTION

In the following detailed description and in the several figures of the drawing, like elements are identified with like reference numerals.

An automatic leveling mount system is described. An exemplary embodiment is a device that provides rotary damping to a mounted device, e.g. a camera system, when mounted to a moving arm. As the arm changes attitude, the mount system allows dampened rotary movement of the mounted device about an axis, due to gravity forces. The rotary damping may facilitate keeping the mounted system pointed at a desired location, e.g. a target, while in motion. The rotary damper functionality may keep the mounted device from swinging or oscillating in an undesired or uncontrolled manner.

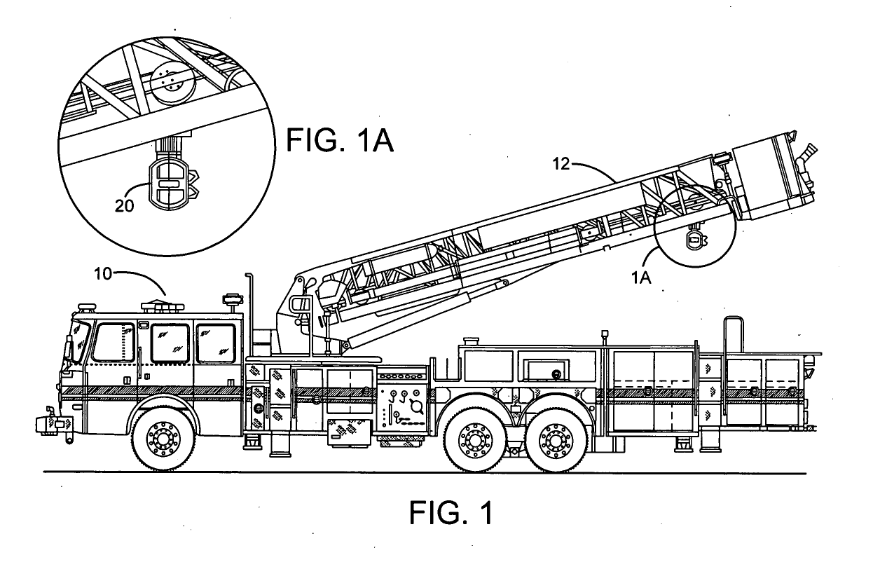

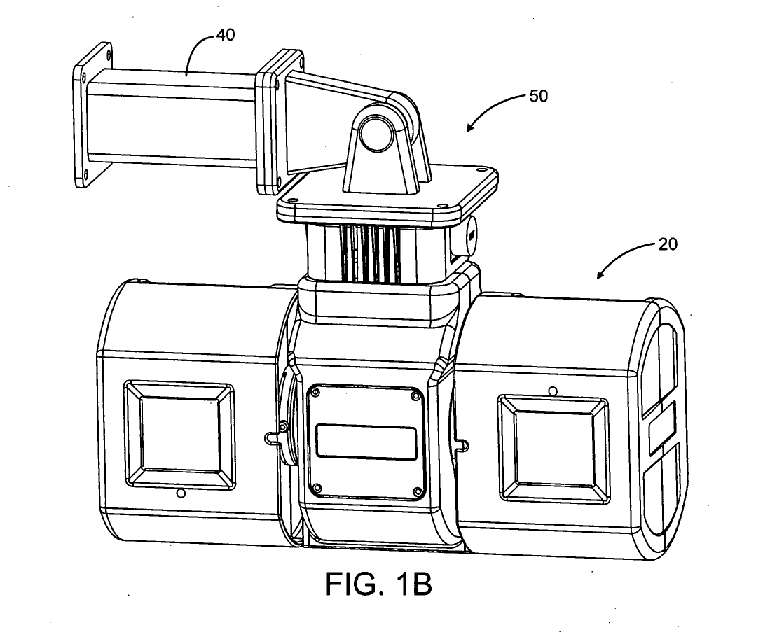

Consider the mounted device 10 shown in FIG. 1, a fire engine 10 with a raisable, extensible boom arm 12. Mounted on the boom arm 12 is a camera system 20, also shown in FIG. 1A. In an exemplary embodiment, the camera system may be a remote controllable system having pan and tilt capability relative to its mount. An exemplary camera system suitable for the purpose is the “VideoSentinel” scene surveillance camera system, marketed by Intec Video Systems, Inc., Laguna Hills, Calif. The camera system may provide a remote imaging capability for the boom operator or other fire fighting personnel. As the boom arm is raised or extended, the pointing direction of the camera system may be altered if the camera system is fixedly attached to the boom.

An embodiment of an automatic leveling mount system may be employed to connect the camera system or other mounted device to the movable boom arm 12. For example, as shown in FIG. 1B, a mount system 50 may be used to attach a camera system 20 to a sub-mount 40, which is attached to a movable arm such as boom arm 12. As the arm is moved to change attitudes relative to horizontal, the camera pointing direction may be maintained due to the gravity self-leveling action of the mount 50.

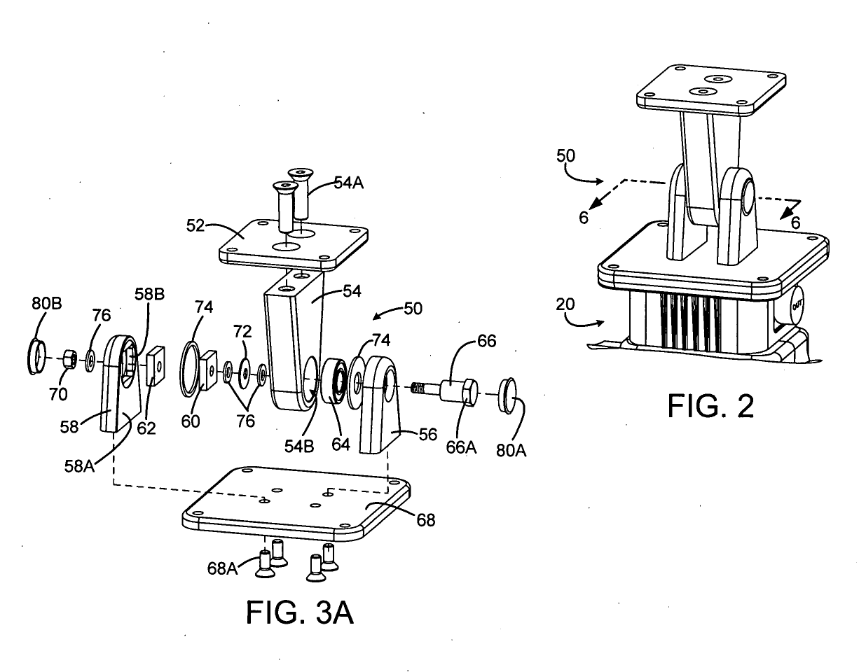

An exemplary embodiment of the mount system 50 is depicted in the isometric view of FIG. 2, assembled to a camera system 20.

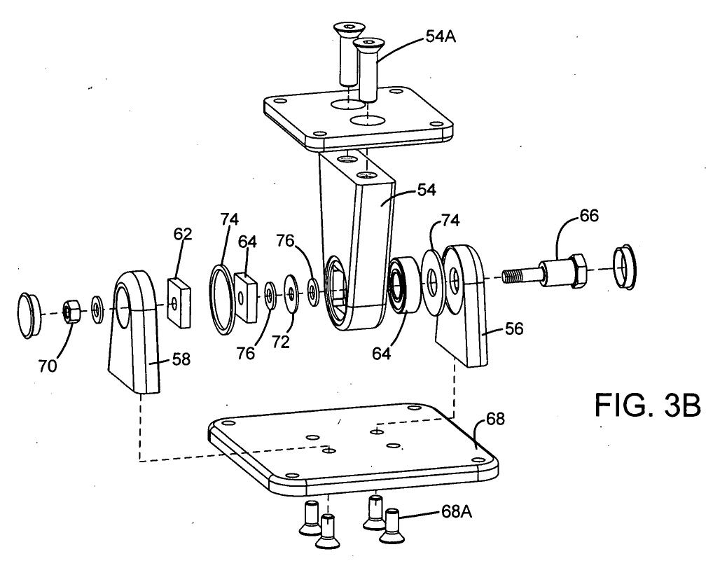

FIGS. 3A-3B are respective exploded isometric views of an exemplary embodiment of a mount system 50. The embodiment of the mount system includes a hanger plate 52, which may be attached to a movable arm or to a sub-mount attached to a movable arm in an exemplary embodiment. A hanger member 54 is attached to the hanger plate, e.g. by threaded fasteners 54A. A distal end of the hanger member 54 has a transverse opening 54B formed therein, into which a bearing 64 is assembled, and through which a mount fastener 66 is passed.

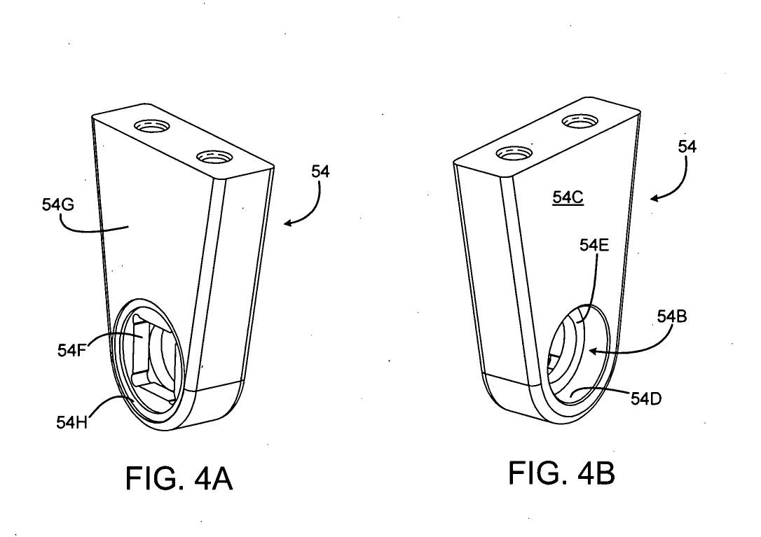

In an exemplary embodiment, the mount system further includes a base plate 68. First and second base mount members 56 and 58 are attached in a spaced relationship to the base plate 68, e.g. by threaded fasteners 68A. The base mount members have openings 56A, 58A formed in their respective distal ends. When the mount system is in an assembled condition, illustrated in FIG. 2, and in FIG. 4, the hanger member 54 is sandwiched between the base mount members 56 and 58, and rotation about fastener 66 may be permitted through a range of movement.

An exemplary embodiment of a mount system 50 may operate as a rotary damper by utilizing two friction plates 60, 62 that are in contact with one another. In this exemplary embodiment, the two friction plates 60, 62 are mounted relative to two separate members 54 and 58 in the mount system. One member (e.g. base mount 58) is fixed to the mounted device (e.g. camera system 20) while the other member (e.g. hanger 54) is fixed relative to the moving arm (e.g. arm 12). In an exemplary embodiment, the friction plates are each 1″ by 1″ with a 0.25 inch thickness, and are fabricated from black Delrin (TM), a lubricated material having the following characteristics: Tensile Strength: 10,000 psi per ASTM D638, Impact Strength: 2.3 ft.-lbs./in. per ASTM D256, Coefficient of Friction: .2, Dielectric Strength: 500 V/mil per ASTM D149, Hardness: Rockwell M:94 per ASTM D785, Coefficient of Thermal Expansion: 6.8×10-5 in./in./OF per ASTM D696. This material is merely exemplary; the friction plates may be fabricated from other materials as well.

In an exemplary embodiment, the amount of normal force between the friction plates may determine the amount of damping. In an exemplary embodiment, the amount of normal force may be adjustable by means of a fastener 66 and nut 70 that clamps the two friction plates. In an exemplary embodiment, a Belleville type disc spring 72 may be employed between flat washers 76 to further enhance the adjustability of the normal force. The disc spring may provide a greater range of adjustability to the normal force on the friction plates. Tightening the fastener and nut increases the amount of normal force while loosening the fastener and nut decreases the normal force.

A roller bearing 64 may be used to provide smoother operation in the rotating direction of the system. In an exemplary embodiment, the assembly may employ flat nylon washers 75 to provide electrical insulation between the base mount 58 and hanger 54. Caps 80A-80B may be employed to cover the exposed ends of the fastener 66 and nut 70.

FIGS. 4A-7 provide further details regarding elements of an exemplary embodiment of the mount system 50. FIGS. 4A-4B depict the hanger 54, with through opening 54B formed through one end. The through opening has a complex geometry. A counter bore portion 54D is formed from the outside surface 54C, to create a recess and shoulder 54E for receiving and supporting the bearing 64. From the inside surface 54G, a generally square recess 54F is formed, in the configuration of the perimeter of the friction plate 60. The recess 54F is shaped to receive the friction plate 60. Also formed from the inside surface 54G is a shallow peripheral recess 54H, for seating the washer 74.

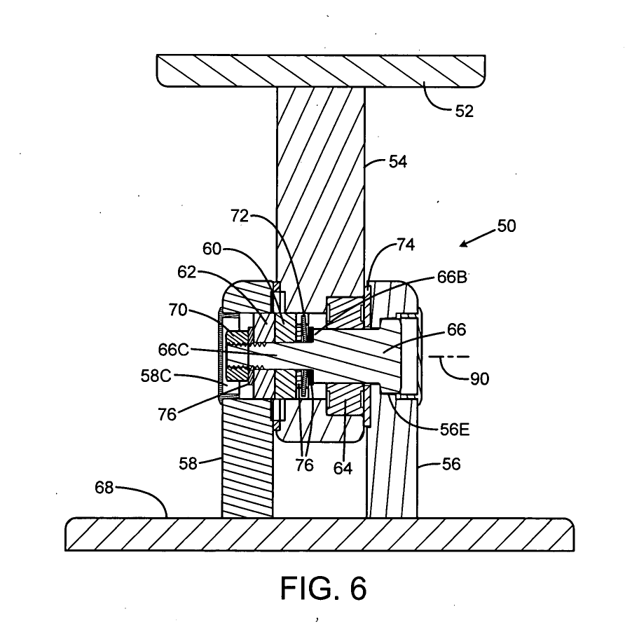

The left base mount 58 has an inside surface 58A, with a generally square recess 58B formed in the opening 58C (FIG. 6). The recess is shaped to the outer configuration of the friction plate 62, so that the friction plate 62 may be received in the recess.

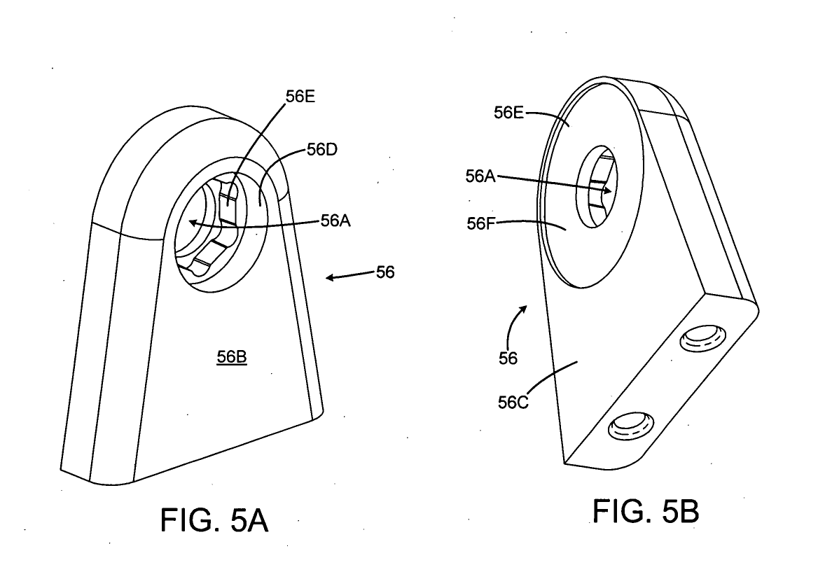

FIGS. 5A-5B depict an exemplary embodiment of a right base mount 56. The base mount 56 has a through opening 56A which has a complex configuration. From the outside surface 56B, a recess 56D is formed, e.g. by a counter bore. The recess transitions to a socket configuration 56E, which is shaped to receive the head 66A and prevent rotation of the fastener 66 relative to base mount 56 while the head is captured in the socket. From the inside surface 56C of the base mount, a shallow recess 56F is formed to receive washer 74.

FIG. 6 illustrates in cross-section an exemplary assembled configuration of an embodiment of the mount system 50. The body of the fastener 66 is passed through the openings in the base mounts 56 and 58, and in the hanger 54. The bearing 64 is mounted on the body of the fastener 66, and is received in the recess 54D. The bearing 64 thus permits relative rotation of the fastener 66 about axis 90 relative to the hanger 54. The body of the fastener 66 has a distal portion 66C of reduced diameter, forming a shoulder 66B. The disc spring washer 72 is sandwiched between flat washers 76, and this sandwich is captured between the shoulder 66B and the friction plate 60. The distal portion 66C of the fastener is passed through both friction plates 60, 62, and a nut 70 and flat washer 76 is threaded onto the threaded end of the distal portion 66C. The friction plates 60, 62 are mounted in recesses within hanger 54 and base mount 58, and their respective facing surfaces are in frictional engagement. As the nut 70 is tightened on the threaded end of the fastener, compressive force will be applied to the sandwich of disc spring 72 and washers 76, and between the respective friction plates 60, 62. The amount of rotational dampening force created by the frictional engagement of the friction plates 60, 62 can be adjusted by tightening or loosening the nut 70. The disc spring 72 provides additional adjustability range, as it deforms in response to compressive force.

The capability to adjust the frictional rotational force may be useful to provide adjustment for mounted devices of different weights. For example, the camera system 20 may be available in different configurations, of different weights. By adjusting the mount system 50, the rotational dampening force can be adjusted to compensate for the different possible weights.

In an exemplary embodiment, the system 50 provides a gravity self-leveling function to the mounted device 20, as the movable arm 12 is repositioned. This allows the mounted device to maintain its attitude relative to ground, since the gravitational force exerted by the weight of the mounted device will exert a rotational force on the mount system 50. The dampening force resulting from the friction plates will tend to reduce or eliminate undesired swinging or oscillation about the rotational axis.

The mount system 50 may be attached directly to the movable arm in some applications, e.g. through the use of threaded fasteners, or through a sub-mount 40 as illustrated in FIG. 1B. The sub-mount 40 may introduce a fixed 90 degree angular offset, allowing the mount system to be attached to a vertical surface.

Although the foregoing has been a description and illustration of specific embodiments, various modifications and changes thereto can be made by persons skilled in the art without departing from the scope and spirit of the subject matter.

What is claimed is:

1. A gravity mount system for mounting a camera to a movable arm, the mount system comprising:
a first mount attachment structure for attaching to the camera;
a second mount attachment structure for attaching to the movable arm;
the first and second mount attachment structures being coupled together for rotational movement about a rotation axis;
a rotary damper to dampen oscillation of the mounted device about the rotation axis as the movable arm changes attitude relative to the horizontal, comprising a first friction plate mounted to the first mount attachment structure and a second friction plate mounted to the second mount attachment structure so that facing surfaces of the first and second friction plates are in contact, and an adjustable compression mechanism for applying a variable compression force normal to the first and second friction plates to adjust an amount of frictional forces between the first and second friction plates tending to resist said rotational movement.

2. The system of claim 1, wherein the adjustable compression mechanism includes a disc spring under compression by the compression mechanism.

3. The system of claim 1, wherein the first and second mount attachment structures are supported for rotational movement about the rotation axis by a roller bearing.

4. The system of claim 1, wherein the friction plates are fabricated of a lubricated material.

5. The system of claim 1, wherein the movable arm is mounted on a wheeled vehicle.

6. A mount system for mounting a camera system to a movable arm, the mount system comprising:
a hanger member secured to the movable arm or to the camera system;
first and second base mount members secured in a spaced relation relative to the other of said movable arm and the camera system, a first portion of the hanger member positioned between first portions of the first and second base mount members;
a pivot mechanism for permitting relative pivoting movement between the hanger member and the first and second base mount members as the movable arm changes attitude relative to the horizontal;
an adjustable dampener providing frictional forces tending to oppose said pivoting movement to reduce or eliminate undesired swinging or oscillation of the camera system relative to the movable arm, and wherein the dampener includes an adjustment mechanism to reduce or increase the frictional forces.

7. The system of claim 6, wherein the pivot mechanism is adapted to permit rotational movement between the hanger member and the first and second base mount members through a range of movement about an axis of rotation.

8. The system of claim 6, wherein the adjustable dampener includes a first friction plate member fixed in relation to the hanger member, a second friction plate fixed in relation to the first base mount member and in facing relation to the first friction plate member so that facing surfaces of said friction plate members are in frictional engagement.

9. The system of claim 8, wherein said adjustment mechanism comprises means for adjusting a compressive force between said first and second friction plate members.

10. The system of claim 9, wherein said adjustment mechanism includes a disc spring.

11. The system of claim 8, wherein said first and second friction plate members are replaceable members.

12. The system of claim 6, further comprising:
a hanger plate to which said hanger member is attached;
a base plate to which said first and second base mount members are attached in said spaced relation.

13. The system of claim 6, wherein said pivot mechanism comprises:
a pivot bolt member passed through respective openings in said first portion of said hanger member and said first portions of said first and second base mount members, said bolt member providing a pivot axis;
a threaded fastener member for engaging a threaded end of the bolt member.

14. The system of claim 6, wherein the pivot mechanism includes a bearing structure to facilitate said relative pivoting movement.

15. The system of claim 6, wherein the movable arm is mounted on a wheeled vehicle.
